(19) United States
(12) Patent Application Publication
(10) Pub. No.: US 2005/0062336 A1
(43) Pub. Date: Mar. 24, 2005

(54) Non-rotating display wheel cover

(75) Inventor: Michael Rutterman, Brisbane (AU)

Correspondence Address: Charles J. Prescott, P.A., Suite 115, 2033 Wood Street, Sarasota, FL, 34237, US

(73) Assignee: Leslie Hsiao, Orlando, FL (US)

(21) Appl. No.: 10/665,773

(22) Filed: Sep. 18, 2003

(51) Int. Cl. B60B 7/14

(52) U.S. Cl. 301/37.371

(57) ABSTRACT

A non-rotating display wheel cover assembly connectable to a rotatable wheel and supporting axle of a vehicle. An inner member including a support bearing member with inner member mounting apertures which are adapted to align and fit onto threaded axle lugs. A plurality of elongated wheel attaching first lug nuts are each threadably engagable from one end thereof onto one of the wheel lugs to rigidly connect the wheel to the axle. Another end of each first lug nut receives a second lug nut after the inner member is positioned thereover whereby said inner member is secured to the wheel and axle. A wheel cover is supported for rotation by the support bearing member. An elongated locking member releasably locks the inner member and wheel cover together for relative rotation only therebetween. A counterweight attached to the wheel cover prevents substantial rotation of the wheel cover.

### CROSS-REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to vehicle wheel covers, and more particularly to a commercial display wheel cover including a replaceable display disc which remains substantially stationary with respect to the vehicle while the vehicle is moving.

2. Description of Related Art

The central outer portion of a vehicle wheel, being fully viewable while the vehicle is in motion, provides an opportunity for the placement of readable graphics in this otherwise merely decorative or unornamental portion of the wheel of larger utility vehicles such as buses or trucks as well as all passenger cars. The utilization of this otherwise merely unadorned space is contingent upon the readability of graphics and word messages being held relatively stationary with respect to the vehicle in motion. A number of prior art patented inventions address this display and advertising opportunity.

In U.S. Pat. No. 5,659,989, Hsiao teaches a wheel cover which includes an outer disc member which is rotatably mounted to an inner base member so that the display indicia applied to the disc member will remain substantially rotation free under vehicle movement. This disclosure includes stabilizing structure to maintain alignment and restrict oscillation of the outer disc member bearing the viewable indicia thereon.

Boothe, in U.S. Pat. No. 5,957,542 discloses a theft-proof, non-rotational wheel cover with replaceable ornamental outer surface. This arrangement relies upon and is engageable within the central cavity of the automotive wheel.

Another advertising display device for a vehicle wheel is disclosed by Ryan in U.S. Pat. No. 2,548,070. In this arrangement, however, the device is adapted for attachment to a non-rotatable axle of the motor vehicle.

In U.S. Pat. No. 2,869,262, Lucas teaches another wheel-supported advertising sign arrangement which appears to attach in rotatable fashion to the outer hubcap of the wheel assembly.

In the disclosure of Kovalenko, in U.S. Pat. No. 4,280,293, a stationary display member is attachable to the vehicle hub and utilizes a flowable material such as mercury acting upon veins within a chamber of the device to substantially eliminate rotation of the bearing-mounted outer display member.

A non-rotating wheel cover assembly shown in U.S. Pat. No. 5,588,715 invented by Harlen teaches yet another wheel cover assembly which is attachable to the outer end of an axle by separate bracketry to support the bearing mounted display member. A thickened lower portion of the wheel cover provides sufficient counterbalance to inhibit or prevent rotation of the display cover while the vehicle is in motion.

Matsushita discloses a free wheel cap in U.S. Pat. No. 4,678,239 which teaches a non-rotating wheel cover having a counterbalanced disc-like body which is bearing connected to an inner multi-arm structure having spring-like clips connected at the outer periphery of the device which interengage with the wheel rim.

Another wheel cover was invented by Okamoto and disclosed in U.S. Pat. No. 6,120,104 teaching a flexible side feature connected to the center of the wheel in support of a display wheel cover. An air current guide is formed into the display cover which assists in stabilizing the display portion without substantial rotational movement as the vehicle is moving.

Other prior art devices which teach vehicle wheel display covers are as follows:
U.S. Pat. No. 710,195 to Jones
U.S. Pat. No. 2,014,058 to Tonai
U.S. Pat. No. 2,169,237 to Gasco
U.S. Pat. No. 4,781,419 to Boothe
U.S. Pat. No. 5,190,354 to Levy
U.S. Pat. No. 5,490,342 to Ruterman

U.S. Pat. No. 6,536,848 discloses a display wheel cover which is substantially non-rotating with respect to the vehicle when in motion and which, in a preferred embodiment, utilizes a unique inner member having an elongated hat-shaped section that facilitates attachment to the rim of the wheel by threadably adjustable rim-engaging members that align into the concave groove formed in the outer wheel rim. A unique cam-locking device both retains the outer display wheel cover in place and also prevents its theft removal as a separate security feature requiring a special tool for removal.

### BRIEF SUMMARY OF THE INVENTION

This invention is directed to a display wheel cover assembly uniquely connectable to a rotatable wheel of a vehicle. This invention includes an inner member rigidly connectable by unique replacement lug nuts to the outside of the wheel serving as combination spacers and lug extensions and having a support-bearing member positioned coaxially with the wheel. Another embodiment includes double-ended lugs which first threadably engage into at least some of the lugs attached to threaded holes formed into the axle hub of heavy trucks. A wheel cover having a coaxially extending support shaft is rotatably supported in the support-bearing member. An elongated cylindrical locking member is positioned within a longitudinal aperture formed through the support shaft. A cam member, connected to a distal end of the locking member, has a non-symmetric periphery such that, when properly rotatably orientated, are fully insertable into said support bearing member. In a second rotational orientation, the cam member prevents withdrawal of the support shaft from the support-bearing member. A counterweight attached to the wheel cover prevents rotation of the wheel cover. Interchangeable display indicia attach to the wheel cover.

It is therefore an object of this invention to provide a non-rotating wheel cover for commercial utility vehicles, trucks and automobiles which will facilitate the application of decorative and readable commercial display indicia such as in advertising while the vehicle is moving.

It is yet another object of this invention to provide an advertising display cover for the wheel of a commercial vehicle which is easily interchangeable and which is rendered secure from inadvertent or theft removal by a unique locking arrangement.

Still another object of this invention is to provide an advertising display cover for the wheel of a vehicle which receives support from the lugs of the axle of the vehicle through the use of uniquely configured double-duty wheel lug nuts serving as spacers and lug extensions.

In accordance with these and other objects which will become apparent hereinafter, the instant invention will now be described with reference to the accompanying drawings.

### BRIEF DESCRIPTION OF THE SEVERAL VIEWS OF THE DRAWING(S)

FIG. 1 is an exploded perspective view of one embodiment of the invention shown in conjunction with a wheel of a vehicle.

FIG. 1A is an exploded perspective view of another embodiment for attachment to vehicles having a central axle hub bolt pattern.

FIG. 2 is an exploded side elevation view in section of FIG. 1 also showing the axle of the vehicle.

FIG. 3 is an enlargement of the central area of FIG. 2 assembled.

FIG. 4 is an inside elevation view of FIG. 6.

FIG. 5 is a section view in the direction of arrows 5-5 in FIG. 4.

FIG. 6 is an inside perspective view of the support shaft and locking mechanism which is mechanically attachable to the inner surface of the wheel cover as shown in FIGS. 1 to 3.

FIG. 7 is an enlarged perspective view from the wheel side of the central area of the inner member and locking mechanism.

### DETAILED DESCRIPTION OF THE INVENTION

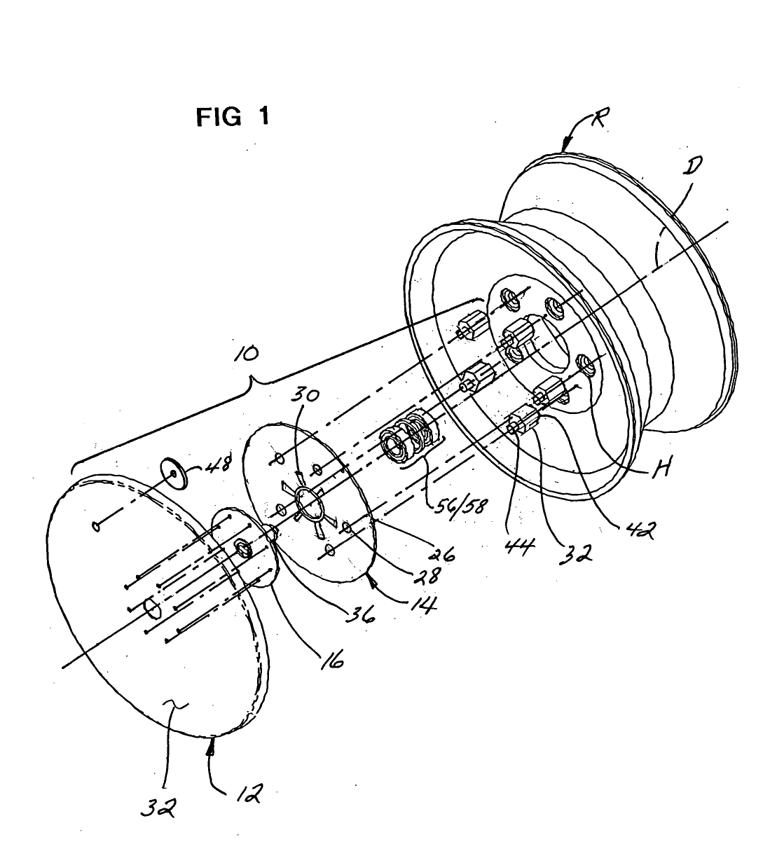

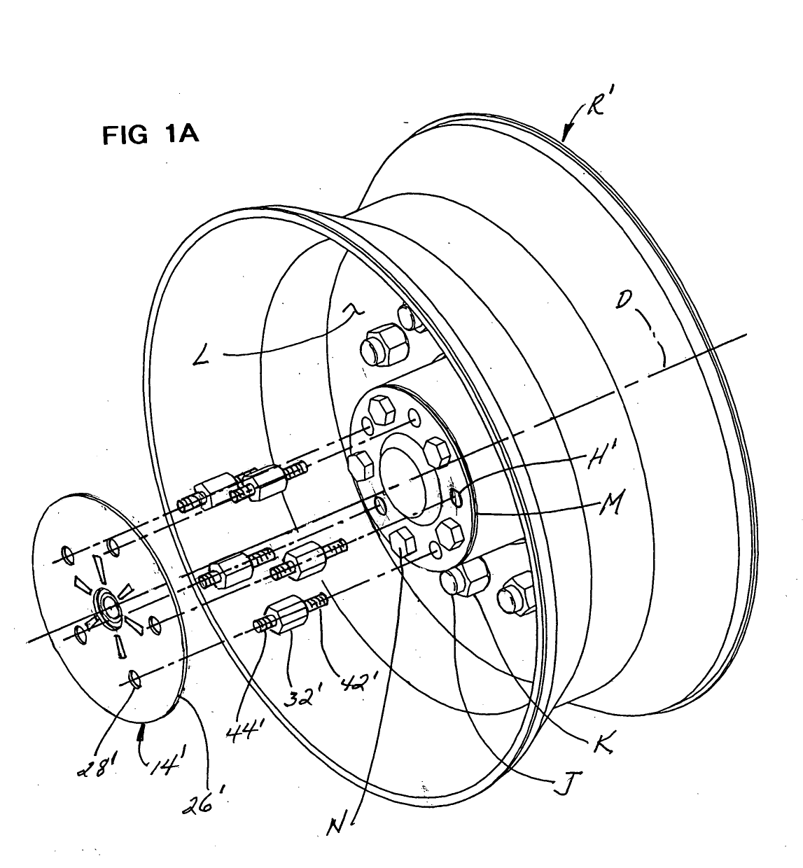

Referring now to the drawings, the preferred embodiment of the invention is shown in FIG. 1 generally at numeral 10. An alternate embodiment is shown generally at numeral 10′ in FIG. 2, the difference in the embodiments 10 and 10′ being in the forms of the outer wheel covers 12 and 12′. Each of these wheel cover assembly embodiments 10 and 10′ are attachable to a wheel R of a preferably commercial vehicle (not shown), the wheel R supporting a conventional inflatable pneumatic tire (not shown) for supporting the vehicle. The wheel cover assemblies 10 and 10′ each include the outer wheel cover 12 or 12′, respectively, having a replaceable disc-shaped display member 32 or 21, respectively, attached to the outer surface thereof. These display members 32 and 21, preferably in the form of adhesive backed thin film imprinted with any desired viewable indicia, may each bear any form of commercial advertising indicia as desired and may be replaced with another display member having a different commercial message at appropriate times. Facilitated by the present invention 10 and 10′, then, the readable indicia on each display member 32 and 21 are maintained in a stationary orientation with respect to the vehicle even while the vehicle is in motion.

Each of the assemblies 10 and 10′ also includes an inner member shown generally at numeral 14 connectable for relative rotation only to the outer wheel cover 12 as described herebelow. The inner member 14 includes a generally flat disc-member 26 which is circular about a centerline D coaxial with the center line of the rim R of the wheel W. Circular wheel cover 12 in FIG. 1 receives the generally flat circular display or advertising disc 32 attached thereto by conventional means (not shown). The wheel cover 12′ in FIG. 2 also includes an elongated cross sectional configuration, the circular, flat outside surface 22 receiving the generally flat circular display or advertising disc 21 attached thereto by conventional means (not shown). The outer periphery 20 of the wheel cover 12′ extends outwardly and inwardly from the generally flat central portion 18 so as to protectively surround the outer periphery of the inner member 14.

The circular disc 26 includes apertures 28 which are adapted to align with the size, spacing and configuration of wheel lugs G seen in FIG. 2 attached to the axle of a drive line B. These lugs G also pass through the wheel mounting holes H of the wheel R.

A uniquely configured elongated wheel attaching lug 32, also acting as a spacer or lug extension, is also provided. One end 42 of this lug or lug extension 32 is adapted to threadably engage over the lug G after the wheel R is positioned against axle A to effect secure installation of the wheel R. Note that at least three, and alternately up to all, of the lugs G receive one of the elongated threaded lug extensions 32, the remaining lugs receiving one of the existing lug nuts (not shown) for economy. However, it is envisioned that at least three of the threaded lugs or extensions 32 would be required to stabilize the installation of the inner member 14 as described immediately herebelow.

After the wheel R is secured to the lugs G of axle A, the circular disc 26 is fitted onto the opposite end 44 of each of the lugs 32 through its mounting holes 28. Thereafter, lug nuts 62 are tightened in place onto threaded portion 44 to effect full and secure installation of the inner member 14. Note that, for economy, the existing lug nuts originally installed on lugs G by the vehicle manufacturer may be used in place of the lug nuts 62 provided. Circular disc 26 is provided with material lightening apertures 30 for economy and inspection purposes. Note also that lug extension 32 may be of any selected overall length which will establish a desired spaced relationship between the inner member 14 and the facing surface of wheel R.

Referring now to FIG. 1A, a rear axle flange M associated with large trucks and busses is assembled together by lugs N through mating apertures H′ which are separate from the lugs J and lug nuts K which attached the rim R′ to the axle of the truck or bus. The larger bolt circle for the wheel mounting lugs J and lug buts K are formed into the central web L of the rim R′ as shown.

To accommodate this axle hub M arrangement, an elongated attaching lug 32′ is provided. This attaching lug 32′ has a first end which is threaded similar to lug N and is threadable into the threaded cavities H′ of the axle hub M. Typically, there are eight or ten such lugs N utilized to assemble the axle hub M and it is thus preferred to replace only a portion (typically three) of those standard lugs N by the attaching lugs 32′.

As previously described, the inner member 14′ includes a flat disc member 26 having apertures 28′ which are sized in diameter and adapted to align with, the spacing and configuration of the bolt pattern of the axle hub M. After the attaching lugs 32′ are installed into a portion of the threaded holes H′, the threaded opposite ends 44′ of the attaching lugs 32′ are passed through the mounting holes 28′ and thereafter, lug nuts (not shown) are threadably tightened in place onto each of the threaded portions 44′ to effect full and secure installation of the inner member 14′.

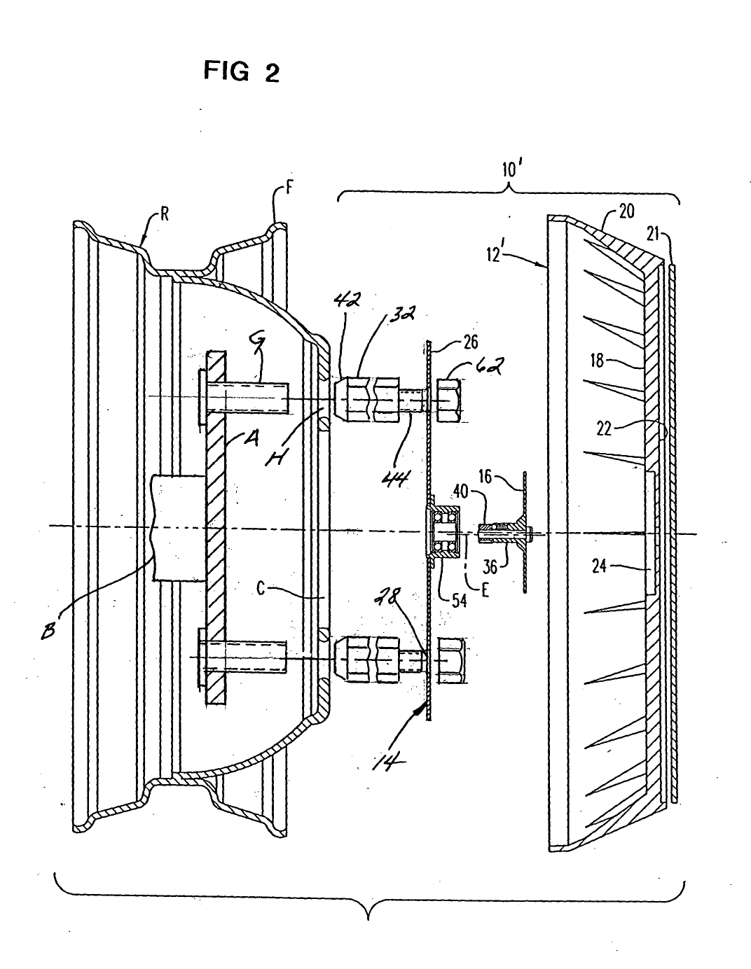

As best seen in FIGS. 2 and 3, the inner member 14 further includes a support bearing member 54 which is rigidly connected to the outer surface of member 26 by its annular flange 54b and radial flange 54a. Included within the support bearing member 54 are two spaced roller bearings 56 and 58 which supportively receive a support shaft 36 having an enlarged mounting flange 16 which is rigidly attached to the central inner surface of the wheel cover 12′ within a mating cavity 24 by threaded evenly spaced threaded fasteners 59. The mounting flange 16 is alternately rigidly attached to the inner surface of wheel cover 12 by threaded fasteners 59 (not shown in FIG. 1). For lighter-duty vehicles, fasteners 59 are eliminated and replaced by over molding mounting flange 16 when mold forming the wheel cover 12′.

The outer cylindrical surface of the support shaft 36 is closely aligned for snug or close sliding fit within the inside diameter of the support bearings 56 and 58. By this arrangement, the support shaft with the display cover 12 rigidly connected thereto and outwardly positioned therefrom, is slidably engageable into the bearings 56 and 58 of the support bearing member 54.

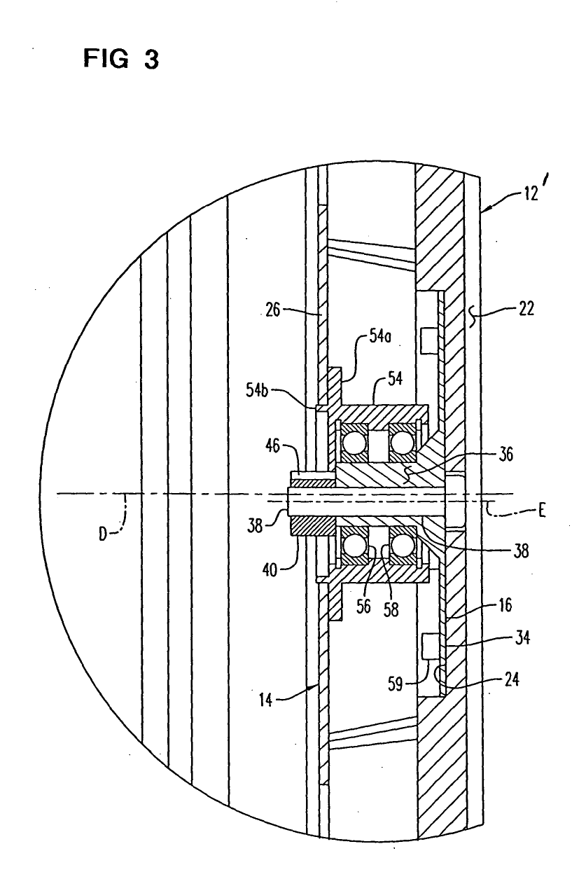

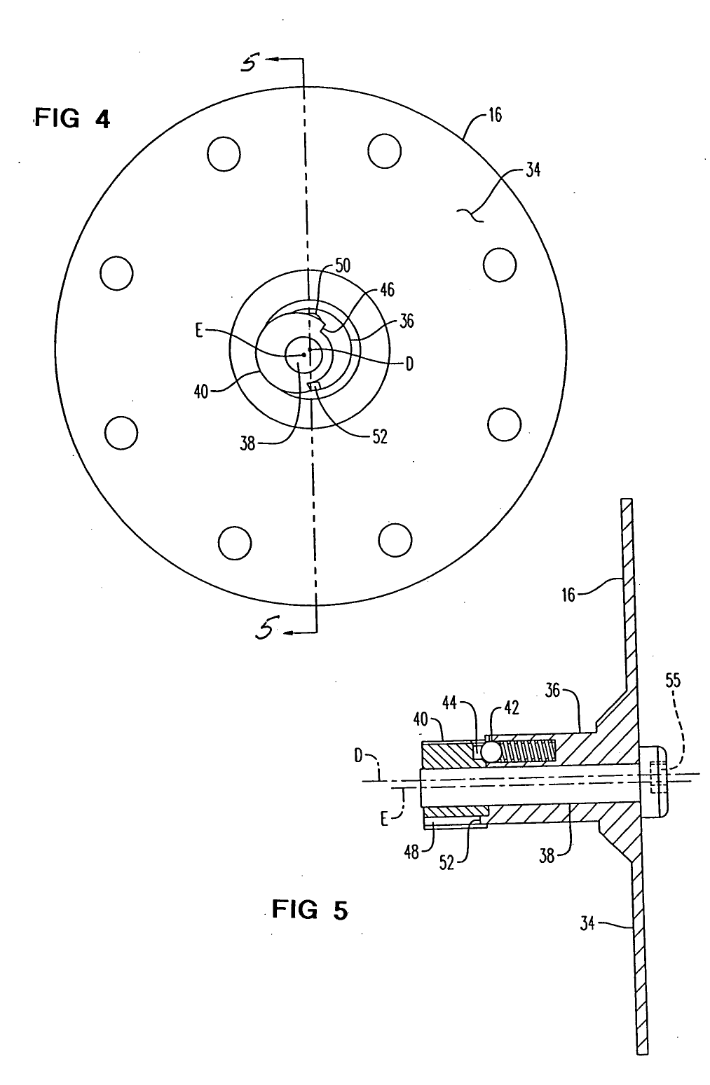

The locking and anti-theft features of the invention are best seen in FIGS. 3 to 7. An elongated cylindrical locking member is there shown at numeral 38 including an elongated cylindrical shaft and an enlarged headed portion having a unique drive slot 55 formed therein. The locking member 38 snugly and slidably engages within an elongated aperture formed longitudinally through the support shaft 36. Note importantly that the axis E of the elongated locking member 38 is offset from the longitudinal axis D which is concentric with the outer cylindrical surface of the support member 36, the wheel W and the inner member 14.

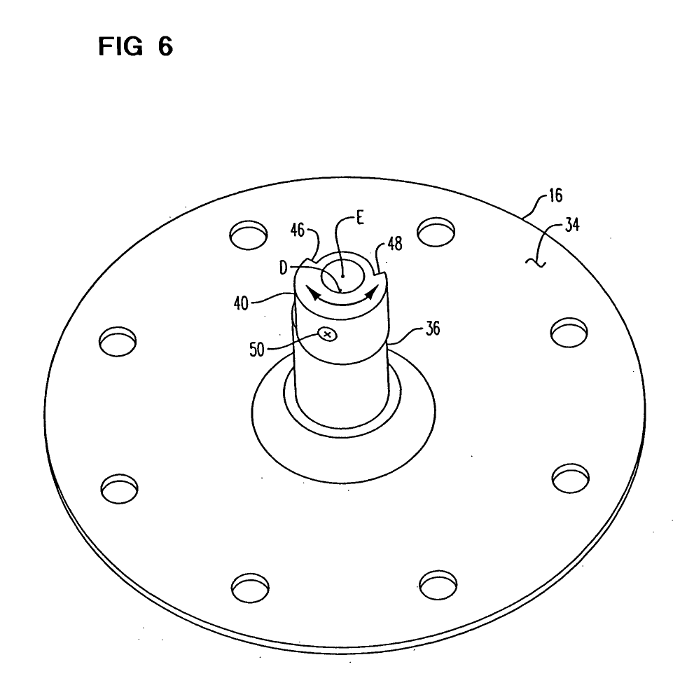

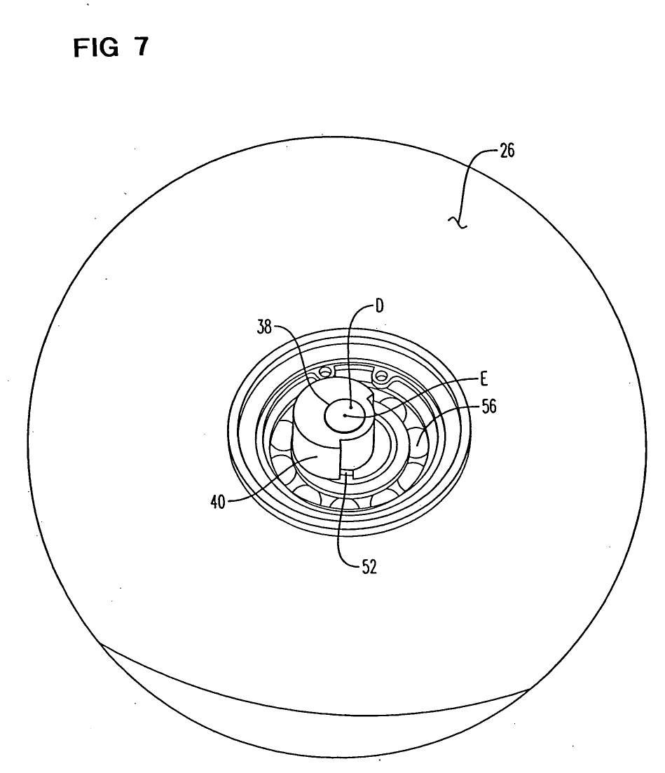

A cam member 40 is mechanically attached by a set screw 50 to the distal end of the locking member 38. A detent ball 42 and spring as seen in FIG. 6 form a detent which snapably engage into a cavity 44 formed in the inner face of the cam 40 which mates against the distal end surface of the support shaft 36. A tab 52, which extends inwardly from the distal surface of the support shaft 36, engages against a notched surface 46 or 48 of the cam member 40 to limit the rotation in the direction of the arrow about axis E as best seen in FIG. 7.

By this arrangement, the cam member 40 may be moved into a rotational orientation as shown in FIG. 6 so that it is in substantially cylindrical alignment within the cylindrical projected envelope defined by the support shaft 36 allowing insertion of the support shaft 36 into the support bearing member 54 as best shown in FIG. 7. Thereafter, the locking member 38 may be rotated to another orientation of the cam member 40 by the insertion of a uniquely configured turning member or key (not shown) into cavity 55 wherein the cam member 40 rotating about offset axis E, causes an interference against the distal end of the support shaft 36 preventing removal of the wheel cover 12.

By this arrangement of providing a uniquely configured cavity 55 or a key slot arrangement, the locking member 38 may only be rotated into the unlocked position of cam member 40 shown in FIG. 6 for removal of the wheel cover 12 by the holder of such a turning member or key.

Note that the above-described locking cam member 40 and accompanying mechanism may be replaced with a well-known quick-release arrangement such as spring loaded laterally extending locking balls which withdraw upon depressing a release shaft having a tapered ramp portion acting upon the locking balls to effect lateral movement thereof between a locked and a released position of shaft 16 within.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. A non-rotating display wheel cover assembly connectable to a rotatable wheel and supporting axle of a vehicle comprising:
an inner member having a support bearing member centrally positioned on said inner member and also having inner member mounting apertures adapted to align with threaded lugs rigidly attached to and extending from the axle in substantially coaxial alignment with a rotational axis of the wheel and axle;
a plurality of elongated wheel attaching first lug nuts each threadably engagable from one end thereof onto one of the wheel lugs which extend through aligned wheel mounting holes of the wheel whereby the wheel is rigidly connected to the axle by said first lug nuts;
another end of each of said first lug nuts having a threaded lug portion for threadably receiving a second lug nut after said inner member is positioned thereover whereby said inner member is secured in coaxial alignment to the wheel and axle;
a circular wheel cover having a support shaft extending concentrically and orthogonally from an inside surface of said wheel cover, said support shaft supported for rotation in coaxial alignment when fully engaged with said support bearing member;
an elongated cylindrical locking member having a distal end and an enlarged proximal end and rotatably positioned within, and coextensive with, a longitudinal aperture formed through said support shaft;
a cam member connected to a distal end of, and rotatable with, said locking member, said cam member having a non-symmetric periphery with respect to a rotational axis of said locking member and having a first rotational orientation with respect to said support shaft wherein said support shaft and said locking member are fully insertable as a unit into said support bearing member to effect full attachment between said inner member and said wheel cover and a second rotational orientation wherein, after said support shaft and said locking member are fully inserted into said support bearing, said cam member prevents withdrawal of said support shaft from said support bearing member, thus locking said inner member and said wheel cover together for relative rotation only therebetween;
a counterweight attached to said wheel cover to substantially prevent rotation of said wheel cover with respect to the vehicle as the wheel is rotated during vehicle movement whereby an interchangeable display indicia attached to an outer surface of said wheel cover remains substantially upright and readable during vehicle movement.

2. A non-rotating display wheel cover assembly connectable to a rotatable wheel and supporting axle of a vehicle comprising:
an inner member having a support bearing member centrally positioned on said inner member and also having inner member mounting apertures adapted to align with a portion of threaded lugs rigidly attached to and extending from the axle in substantially coaxial alignment with a rotational axis of the wheel and axle;
a plurality of elongated wheel attaching first lug nuts each adapted for threadable engagement at one end thereof onto the portion of wheel lugs positioned through aligned wheel mounting holes of the wheel whereby the wheel is rigidly connected to the axle by said first lug nuts;
another end of each of said first lug nuts having a threaded lug portion for threadably receiving a second lug nut after said inner member is positioned thereover whereby said inner member is secured in coaxial alignment to the wheel and axle;
a circular wheel cover having a support shaft extending concentrically and orthogonally from an inside surface of said wheel cover, said support shaft supported for rotation in coaxial alignment when fully engaged with said support bearing member;
an elongated cylindrical locking member having a distal end and an enlarged proximal end and rotatably positioned within, and coextensive with, a longitudinal aperture formed through said support shaft;
a cam member connected to a distal end of, and rotatable with, said locking member, said cam member having a non-symmetric periphery with respect to a rotational axis of said locking member and having a first rotational orientation with respect to said support shaft wherein said support shaft and said locking member are fully insertable as a unit into said support bearing member to effect full attachment between said inner member and said wheel cover and a second rotational orientation wherein, after said support shaft and said locking member are fully inserted into said support bearing, said cam member prevents withdrawal of said support shaft from said support bearing member, thus locking said inner member and said wheel cover together for relative rotation only therebetween;
a counterweight attached to said wheel cover to substantially prevent rotation of said wheel cover with respect to the vehicle as the wheel is rotated during vehicle movement whereby an interchangeable display indicia attached to an outer surface of said wheel cover remains substantially upright and readable during vehicle movement.

3. A non-rotating display wheel cover assembly connectable to a rotatable wheel and supporting axle of a vehicle comprising:
an inner member having a support bearing member centrally positioned on said inner member and also having inner member mounting apertures adapted to align with a portion of threaded lugs rigidly attached to and extending from the axle in substantially coaxial alignment with a rotational axis of the wheel and axle;
a plurality of elongated wheel attaching first lug nuts each threadably engagable from one end thereof onto the portion of wheel lugs extending through aligned wheel mounting holes of the wheel whereby the wheel is rigidly connected to the axle by said first lug nuts;
another end of each of said first lug nuts having a threaded lug portion for threadably receiving a second lug nut after said inner member is positioned thereover whereby said inner member is secured in coaxial alignment to the wheel and axle;
a circular wheel cover having a support shaft extending concentrically and orthogonally from an inside surface of said wheel cover, said support shaft supported for rotation in coaxial alignment when fully engaged with said support bearing member;
an elongated releasable locking member for releasably locking said inner member and said wheel cover together in spaced apart relation one to another for relative rotation only therebetween;
a counterweight attached to said wheel cover to substantially prevent rotation of said wheel cover with respect to the vehicle as the wheel is rotated during vehicle movement whereby an interchangeable display indicia attached to an outer surface of said wheel cover remains substantially upright and readable during vehicle movement.

4. A non-rotating display wheel cover assembly connectable to an axle hub of a rotatable wheel and supporting axle of a vehicle comprising:
an inner member having a support bearing member centrally positioned on said inner member and also having inner member mounting apertures adapted to align with a portion of threaded axle hub holes formed into the axle hub and in substantially coaxial alignment with a rotational axis of the wheel and axle;
a plurality of elongated attaching lugs each threadably engagable at one end thereof into the threaded axle hub holes;
another end of each of said attaching lugs having a threaded lug portion for threadably receiving a second lug nut after said inner member is positioned thereover whereby said inner member is secured in coaxial alignment to the axle hub, wheel and axle;
a circular wheel cover having a support shaft extending concentrically and orthogonally from an inside surface of said wheel cover, said support shaft supported for rotation in coaxial alignment when fully engaged with said support bearing member;
an elongated releasable locking member for releasably locking said inner member and said wheel cover together in spaced apart relation one to another for relative rotation only therebetween;
a counterweight attached to said wheel cover to substantially prevent rotation of said wheel cover with respect to the vehicle as the wheel is rotated during vehicle movement whereby an interchangeable display indicia attached to an outer surface of said wheel cover remains substantially upright and readable during vehicle movement.
